(19) United States
(12) Patent Application Publication
(10) Pub. No.: US 2019/0014752 A1
(43) Pub. Date: Jan. 17, 2019

(54) BEE HYDRATION STATION

(71) Applicants: Tracie COYNE, Fonthill (CA); Deborah HOFFELE, Fonthill (CA); Vanessa BILSBOROUGH, Fonthill (CA); Jacob CHEUNG, Fonthill (CA); Crystal COYNE, Fonthill (CA); Mason DEFAZIO, Fonthill (CA); Alexander RUBINO, Fonthill (CA); Laura SCHAEFER, Fonthill (CA); Sarah SCHAEFER, Fonthill (CA)

(72) Inventors: Tracie COYNE, Fonthill (CA); Deborah HOFFELE, Fonthill (CA); Vanessa BILSBOROUGH, Fonthill (CA); Jacob CHEUNG, Fonthill (CA); Crystal COYNE, Fonthill (CA); Mason DEFAZIO, Fonthill (CA); Alexander RUBINO, Fonthill (CA); Laura SCHAEFER, Fonthill (CA); Sarah SCHAEFER, Fonthill (CA)

(21) Appl. No.: 16/033,672

(22) Filed: Jul. 12, 2018

Related U.S. Application Data
(60) Provisional application No. 62/531,572, filed on Jul. 12, 2017.

(51) Int. Cl. A01K 53/00

(52) U.S. Cl. CPC A01K 53/00

(57) ABSTRACT

A Bee Hydration Station system and methods are disclosed. The bee hydration station has a flower basin or landing pod for bees to land and to collect water for bees to gather. The flower basin member has at least a first hole and a second hole; a stem member coupled to a bottom portion of the flower basin member; an inflow tube coupled to the first hole of the flower basin member; and an overflow tube coupled to the second hole of the flower basin member.

### RELATED APPLICATIONS

This application claims the benefit of and priority to U.S. Patent Application No. 62/531,572, filed Jul. 12, 2017, the contents of which are incorporated herein by reference.

### FIELD OF THE INVENTION

The present disclosure relates generally to a garden accessory and method of assembling the garden accessory. Particularly, the disclosure relates to a bee hydration system and method.

### BACKGROUND

The honeybee population is in trouble. Typically, the loss of 5-10% of bees over the winter is considered normal and sustainable. However, over the past 12 years that has risen dramatically and even reached 58% in 2015. It is believed that there are four main reasons for this: loss of habitat, disease and mites, pesticides, and climate change.

Bees are very important to the human population for many more reasons than just making honey and pollinating our flowers. Bees also pollinate the plants humans eat. They are responsible for pollinating 1 in every 3 bites of our food. It is estimated that if bees disappeared the human race would not survive more than 4 years.

The overall health of bees can be improved to counter the loss of habitat and harm from the pesticides by helping to provide clean water for the bees so they can continue to supply pollen and nectar.

A bee requires its weight in water every day. The average beehive of bees therefore requires approximately 3 gallons of water each day. Bees need help to get clean water which is not contaminated with pesticides such as neonicotinoids from farm fields or chlorine from local pools.

### SUMMARY

In various examples disclosed herein, the present disclosure describes a bee hydration station for providing water to bees. In example aspects, a flower basin is designed with multiple landing places for bees with a controlled depth to allow bees to safely receive water without drowning. In one example aspect there is provided a bee hydration station comprising: a flower basin member, the flower basin member defining at least a first hole and a second hole; a stem member coupled to a bottom portion of the flower basin member; an inflow hose coupled to the first hole of the flower basin member; and an overflow hose coupled to the second hole of the flower basin member.

In a further example embodiment there is provided a bee hydration station comprising: a basin member defining a water collection area that is fed by an inflow hole and drained at an overflow hole, the basin member including a bee landing area adjacent the water collection area; a stem member having a first end attached to the basin member and a second end securable to a supporting medium, the stem member being configured to support the basin member with the water collection area in an upward facing position when the stem member second end is secured to the supporting medium; an inflow tube that extends along at least a part of the stem member, the inflow tube having a first end coupled to the inflow hole and a second end for coupling to a water source; and an overflow tube that extends along at least a part of the stem member, the overflow tube having a first end coupled to the overflow hole and a second end for discharging water.

Methods of assembling the bee hydration station are also provided.

### BRIEF DESCRIPTION OF THE DRAWINGS

Reference will now be made, by way of example, to the accompanying drawings which show example embodiments of the present application, and in which:

FIG. 1 is a cross sectional view of a bee hydration station according to example embodiments;

FIG. 2 top view of a bee hydration station bee landing pod or flower basin of the hydration station of FIG. 1;

FIG. 3 is a side cross sectional view of the embodiment of the bee hydration station bee landing pod or flower basin shown in FIG. 2;

FIG. 4 is a bottom view of the embodiment of the bee hydration station bee landing pod or flower basin shown in FIGS. 2-3;

FIG. 5 is a perspective view of the bee hydration station shown in FIG. 1 connected to a rain barrel; and

FIG. 6 is a top view of a bee hydration station with an overflow tube connected to an overflow soaker hose according to an example embodiment.

### DESCRIPTION OF EXAMPLE EMBODIMENTS

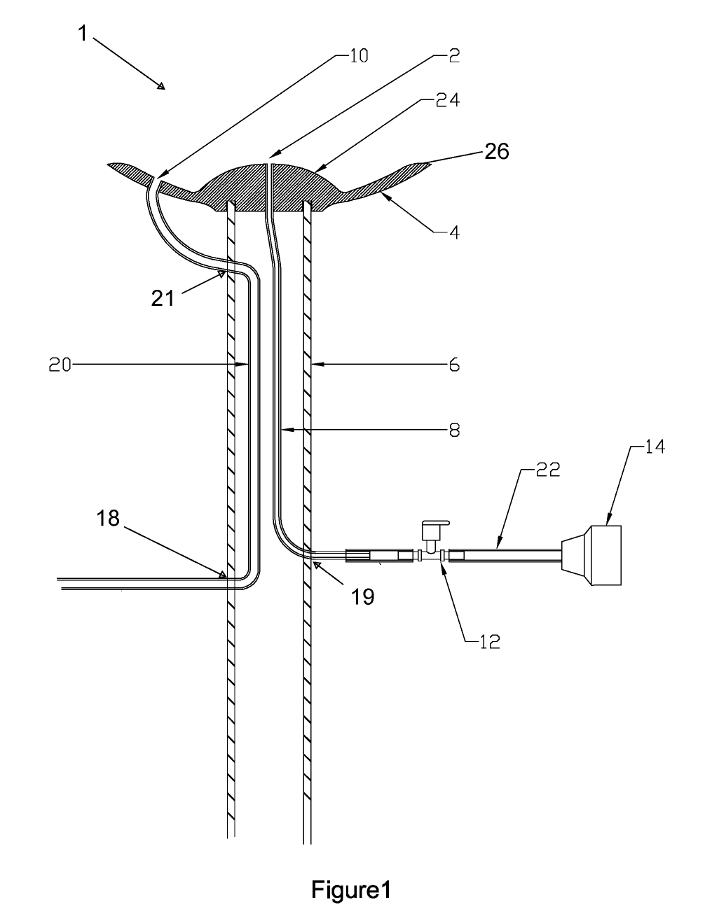

Referring to FIGS. 1 and 5, the present disclosure provides a bee hydration station 1. The bee hydration station 1 includes a flower-shaped basin 4 connectable to a pipe or stem member 6 and overflow tube 20 and inflow tube 8. Inflow tube 8 is connectable to intake hose 22, which may be connected to a rain barrel or hose. The stem member 6 may be elongated and can be inserted into the ground. In example aspects, the flower basin 4 is designed with multiple landing places 26 for bees and with a controlled depth to allow bees to safely receive water without drowning.

In example embodiments of the bee hydration station 1, flower basin 4 has enough space for the bees to land on but still has space for water; the bee hydration station flower basin 4 has a steady flow of water to prevent black mold and mosquito breeding; and a water collection area 24 that is shallow enough to prevent bees from drowning, for example, a basin depth of between 0.1-10.0 mm.

Bees tend to prefer flowers that open upward. In that regard, in an example embodiment the bee hydration station flower basin 4 opens upwards with a gradual slope or incline so bees have places to land, as shown in FIGS. 1 and 3. The slope or incline of flower basin 4 also allows for water to collect in a centre portion.

### Bee Hydration Station Assembly

Referring to FIGS. 1-5, in example aspects, the bee hydration station 1 flower basin 4 includes at least two holes, inflow hole 2 and overflow hole 10. Inflow hole 2 may release water into flower basin 4, and overflow hole 10 may allow for water removal from flower basin 4. In particular, inflow hole 2 is configured to feed water into water collection area 24 of the flower basin 4 and overflow hole 10 is configured to drain water from the water collection area 24 of flower basin 4. Inflow hole 2 is connectable to inflow tube 8 and overflow hole 10 is connectable to overflow tube 20.

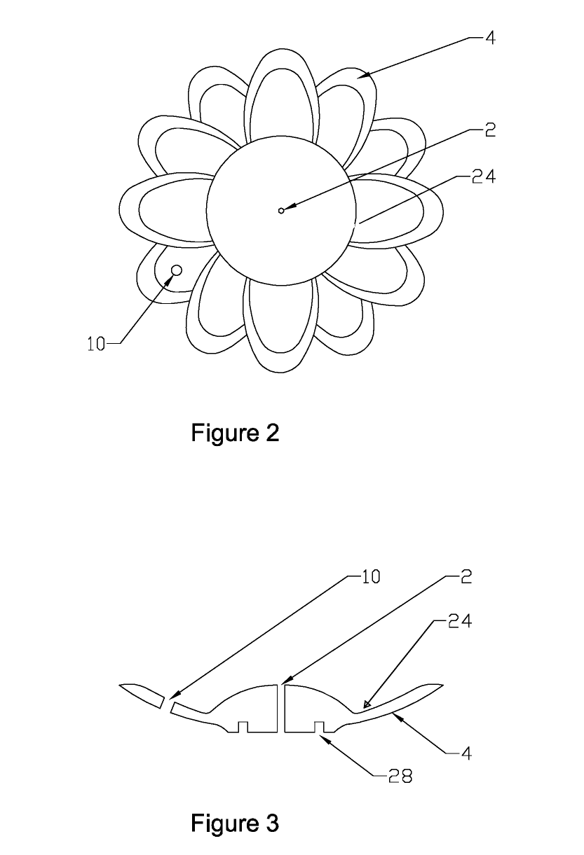

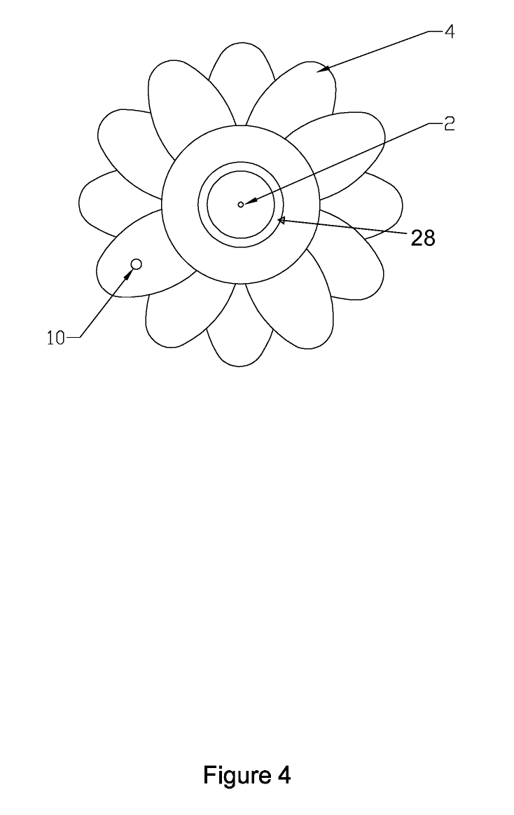

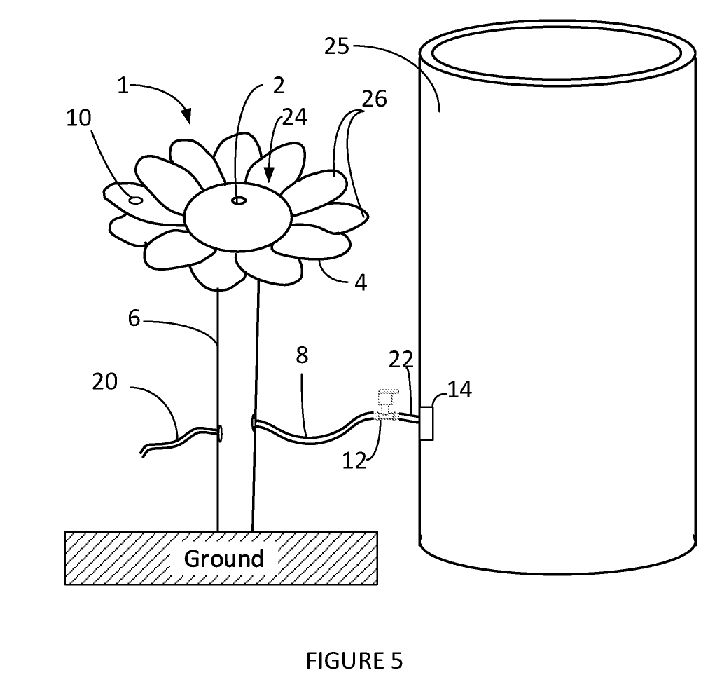

Flower basin 4 includes water collecting area 24, bee landing area 26. As shown in the bottom view of FIG. 4 and sectional view of FIG. 3, flower basin 4 may include one or more inserts 28 for receiving an upper end of stem member 6. In the illustrated example, the insert 28 takes the form of a circular groove or slit for receiving the upper end of tubular stem member 6. A centre of flower basin 4 may be raised to resemble a flower. In the example shown in FIG. 2, an outer portion of flower basin 4 may be constructed to have a plurality of outer rounded portions to resemble flower petals, providing multiple areas for bees to land on landing area 26. In the illustrated embodiment bee landing area 26 surrounds water collection area 24 and is above overflow hole 10 such that the bee landing area 26 is above the level of water collected in water collection area 24.

As disclosed in FIGS. 1 and 5, in example aspects, the bee hydration station 1 comprises a water intake hose 22 connectable to inflow tube 8. Intake hose 22 may have a valve 12 for controlling water flow. In example embodiments, intake hose 22 connects to inflow tube 8, which connects to bee hydration station flower basin 4 inflow hole 2 through stem member 6. Inflow tube 8 can be positioned through stem member 6, which can be hollow, as shown in FIG. 1.

Stem member 6 may have side holes 19 and 18 for inflow tube 8 and overflow tube 20 to respectively pass through. Alternatively, inflow tube 8 and overflow tube 20 may pass through a bottom portion of stem member 6. As shown in FIG. 1, stem member 6 can include a further opening or side hole 21 located close to its upper end that allows overflow tube 20 to extend outside of the stem member 6 to the overflow hole 10.

Pipe or stem member 6 may be connectable to flower basin member 4 via slits or inserts 28 (e.g. a circular groove on the bottom of flower basin member 4 as illustrated in FIGS. 3 and 4) that receives stem member 6. Stem member 6 may also be connected to flower basin 4 by, for example, glue or any suitable adhesive, with or without inserts 28. The lower end of stem member 6 can be secured or connected to a support medium such as the ground or earth—for example stem member 6 can be inserted into the ground or earth outside.

In example aspects, the bee hydration station 1 comprises a connector element (micro-tubing compression adapter) 14 with a filter to attach to a rain barrel 25 or hose which is attached to intake hose 22. In an example embodiment the intake hose 22 is ¼″ tubing.

In example aspects valve 12 controls the rate of flow of water through inflow tube 8, connected to inflow hole 2. The valve 12 is connected to inflow tube 8 which can feed up the pipe or stem member 6 or the “stem of the flower”. In an example embodiment inflow tube 8 is ⅛″ hose.

Referring to FIGS. 1 and 5, the bee hydration station 1 further comprises an overflow tube 20. In example aspects, overflow tube 20 is connected to overflow hole 10 through stem member 6.

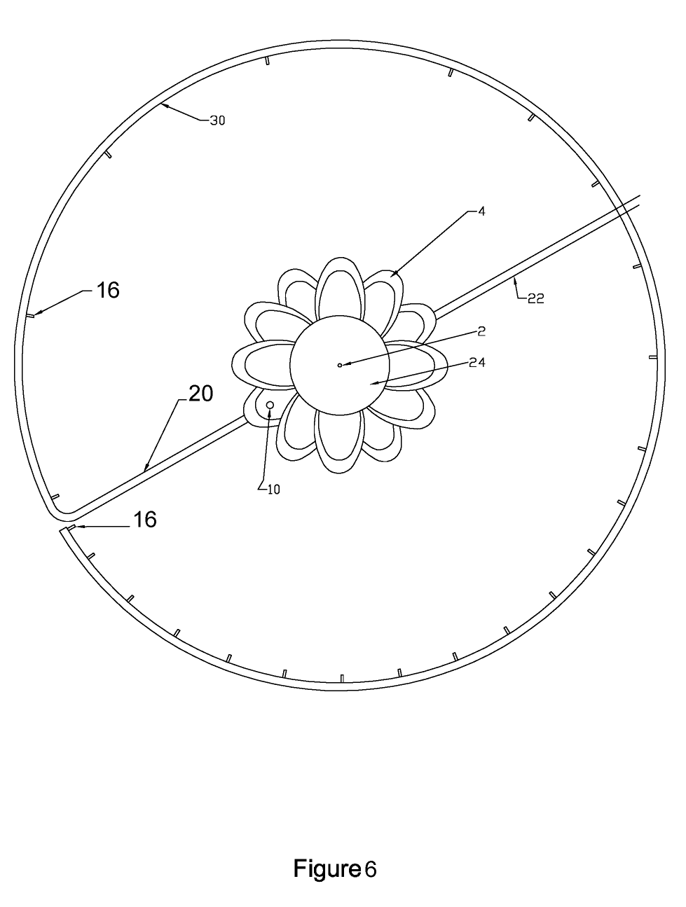

Referring to FIG. 6, in example aspects, overflow tube 20 is further connectable to hose 30. Overflow tube 20 is usable for controlling a water level of flower basin 4 and carries excess water of flower basin 4 to hose 30.

Referring to FIG. 5, in example aspects, hose 30 has a plurality of holes 16 of increasing frequency, which are usable to release water into, for example, the ground or earth, and usable for maintaining relatively constant water pressure throughout at least a portion of hose 30. In further example aspects, hose 30 is usable for watering bee attracting flowers which can be planted near to the bee hydration station 1.

During use, bee hydration station 1 is assembled and positioned so that flower basin 4 opens upwards, with water collection area 24 facing upwards. In other words, an outer portion of flower basin 4 may decline or slope downwards towards a centre of flower basin 4.

The bee hydration station can be positioned or inserted in the ground. In example aspects, a bottom portion of stem member 6 connects to the ground and can be positioned outdoors for attracting bees.

### Example of Water Flow Through the Bee Hydration Station

Referring to FIGS. 1 and 5, in an example aspect, water flows from a rain barrel 25 or other water source such as a hose (rain barrel shown in FIG. 5; hose not shown) through intake hose 22 via connector element 14. Intake hose 22 is connectable to inflow tube 8. Inflow tube 8 is connected to inflow hole 2.

Water can flow from inflow tube 8 out of inflow hole 2, for example as a waterfall or miniature fountain. Inflow hole 2 can be located in a centre portion of the flower basin 4. Water can trickle down from inflow hole 2 to water collecting area 24, a location where bees can collect water. Bees can land on the outer edges of flower basin 4, i.e. landing areas 26 of flower basin 4, and collect water from water collecting area 24.

Referring to FIGS. 1 and 5, in an example aspect, the overflow or excess water collected in flower basin 4 is drained through an overflow hole 10, which is connectable to overflow tube 20.

In an example embodiment, overflow tube 20 is positioned inside pipe or stem member 6. In an example embodiment overflow tube 20 is ¼″ tubing for draining water through stem member 6.

Referring to FIG. 6, in an example embodiment, overflow tube 20 is connectable to hose 30. Hose 30 can be positioned in a radial or circular pattern around the bee hydration station 1, for example, at about 1 foot or 30 cm out from the stem. Hose 30 may have one or more holes 16 at increasing frequency to equalize water flow through the hose 30 (i.e. the spacing between the holes decreases as the distance from the water source increases). This is an example of a “Soaker-style hose”. Hose 30 can be used to water flowers or vegetation that may be planted near bee hydration station 1.

In example aspects, flowers or vegetation can be positioned or planted near tubing 30. Further, flowers or vegetation that bees are attracted to can be positioned near tubing 30 to encourage bees to use the bee hydration station 1 and land on flower basin 4. Additionally, water that flows through tubing 20 and soaker hose 30 can be used to water flowers that are growing nearby.

### Various Uses for the Bee Hydration Station

One use of the bee hydration station 1 is a watering station for bees, to help improve the overall health of the bee colony(s) by providing clean water from a rain barrel or hose. The bee hydration station 1 could be used for: (1) Cooling. In the heat of the summer, some bees create a breeze by flapping their wings as the water evaporates to control hive temperature. (2) Humidity. Worker bees use water to adjust the humidity of the bee hive. (3) Use stored food. Bees need to dilute stored food with water in order to use it as edible food (4) Larvae food. The Nurse Bees use water to make a jelly to feed the larvae.

Other uses of the bee hydration station 1 are: A water source for other pollinators and insects including butterflies, moths, beetles; water source for birds and other animals; plant watering system; and a garden decoration.

### Construction Variations of the Bee Hydration Station

Example materials for constructing bee hydration station 1 will now be disclosed.

In an example embodiment, the flower basin 4 can be 3D printed with Acrylonitrile butadiene styrene (ABS) plastic. The produced flower basin 4 can be made out of a 2 part plastic resin poured into a mold with polyvinyl chloride (PVC) gift cards recycled as filler within the plastic.

In one embodiment, the bee hydration station 1 flower basin 4 is made of plastic resin with a silicone mold. The bee hydration station flower basin 4 can also be made of clay or plastic or any other suitable material. In various embodiments, the flower basin 4 could be made out of: full fill plastic resin (no filler), injection molded plastics, glass, ceramic or molded cement, or post-consumer products such as glass plate and bowls or plastic bottles or jars cut and reshaped into flower basin 4. Alternatively, flower basin 4 could also be made out of paper pulp covered in a water resistant coating such as plastic or rubber.

The stem member 6 could be made from 1¼″ ABS pipe. The stem member 6 could also be made from a pipe of different diameter and different material such as PVC, steel, copper or other such materials. A wooden dowel or branch could also be used.

In an example embodiment the inflow tube 8 is constructed from ⅛″ micro-irrigation tubing, and overflow tube 20 and intake hose 22 are constructed from ¼″ micro-irrigation tubing, although other sizes are possible. This tubing can be made from vinyl or polyethylene. Copper or other materials could also be used.

In example embodiments, the shutoff valve 12 can define a ¼″ passage and be connected in-line between the inflow tube 8 (using a ¼″ to ⅛″ adapter) and the intake hose 22. Connector 14 may for example include a ¾″ to ¼″ adapter to connect to a rain barrel 25 or hose.

In one example the flower basin 4 is shaped like a flower, but it can also be other shapes such as square shaped, rectangular or triangular, circular or oval.

The bee hydration station 1 improves on existing home made solutions and fills a market gap providing value to farmers, gardeners and bee keepers who depend on a strong and healthy bee population for their food production.

The bee hydration station 1 prevents black mold growth and mosquito breeding with continual water flow.

The embodiments of the present disclosure described above are intended to be examples only. The present disclosure may be embodied in other specific forms. Alterations, modifications and variations to the disclosure may be made without departing from the intended scope of the present disclosure. While the systems, devices and processes disclosed and shown herein may comprise a specific number of elements/components, the systems, devices and assemblies could be modified to include additional or fewer of such elements/components. For example, while any of the elements/components disclosed may be referenced as being singular, the embodiments disclosed herein could be modified to include a plurality of such elements/components. Selected features from one or more of the above-described embodiments may be combined to create alternative embodiments not explicitly described. All values and sub-ranges within disclosed ranges are also disclosed. The subject matter described herein intends to cover and embrace all suitable changes in technology.

What is claimed is:

1. A bee hydration station comprising:
a basin member defining a water collection area that is fed by an inflow hole and drained at an overflow hole, the basin member including a bee landing area adjacent the water collection area;
a stem member having a first end attached to the basin member and a second end securable to a supporting medium, the stem member being configured to support the basin member with the water collection area in an upward facing position when the stem member second end is secured to the supporting medium;
an inflow tube that extends along at least a part of the stem member, the inflow tube having a first end coupled to the inflow hole and a second end for coupling to a water source; and
an overflow tube that extends along at least a part of the stem member, the overflow tube having a first end coupled to the overflow hole and a second end for discharging water.

2. The bee hydration station of claim 1 wherein the stem member is a tubular member and the inflow tube and the overflow tube each extend at least partially inside the stem member.

3. The bee hydration station of claim 2 wherein the inflow hole is located at a raised centre of the basin member, and the inflow tube extends through the first end of the stem member to the inflow hole.

4. The bee hydration station of claim 3 wherein the raised centre of the basin member is sloped downward to the water collection area, and the bee landing area surrounds the water collection area.

5. The bee hydration station of claim 4 wherein the basin member is formed from plastic and the bee landing area is configured to simulate pedals of a flower.

6. The bee hydration station of claim 1 comprising a soaker hose extending from the overflow tube, the soaker hose having a plurality of water exit holes.

7. The bee hydration station of claim 6 wherein a spacing between the water exit holes decreases along a length of the soaker hose.

8. The bee hydration station of claim 1 including a valve for controlling a water flow rate in the inflow tube.

9. The bee hydration station of claim 1 including a micro-tubing compression adapter for coupling the inflow tube to a water source.

10. The bee hydration station of claim 1 wherein the second end of the stem member is configured to be secured to the supporting medium by inserting the second end of the stem member into earth.

11. The bee hydration station of claim 1 wherein the basin member includes one or more grooves on a lower surface thereof for receiving the first end of the stem member.

12. The bee hydration station of claim 1 wherein the basin member is configured so that the water collection area has a maximum water retaining depth of 10 mm or less.

13. A bee hydration station comprising:
a flower basin member, the flower basin member defining at least a first hole and a second hole;
a stem member coupled to a bottom portion of the flower basin member;
an inflow tube coupled to the first hole of the flower basin member; and
an overflow tube coupled to the second hole of the flower basin member.

14. The bee hydration station of claim 13, wherein an outer portion of the flower basin member is declined toward a centre portion of the flower basin member.

15. The bee hydration station of claim 13, wherein the inflow tube extends within the stem member to the first hole.

16. The bee hydration station of claim 15, wherein at least a portion of the overflow tube extends within the stem member.

17. The bee hydration station of claim 13, wherein the first hole is positioned in a centre portion of the flower basin member.

18. The bee hydration station of claim 17, wherein the second hole is positioned in an outer portion of the flower basin member that surrounds a water collection area of the flow basin member.

19. A method of providing a bee hydration station for hydrating bees, comprising:
providing a basin member defining a water collection area that is fed by an inflow hole and drained at an overflow hole, the basin member including a bee landing area adjacent the water collection area;
providing an inflow tube having a first end coupled to the inflow hole and a second end coupled to a water source;
providing an overflow tube having a first end coupled to the overflow hole and a second end for discharging water;
attaching a first end of a stem member to the basin member and a second end of the stem member to a supporting medium such that the stem member supports the basin member with the water collection area in an upward facing position.

20. The method of claim 19 wherein attaching the second end of the stem member to the supporting medium comprises inserting the second end of the stem member into earth.
